(19) United States
(12) Patent Application Publication
(10) Pub. No.: US 2022/0006345 A1
(43) Pub. Date: Jan. 6, 2022

(54) COMPRESSED STRAND, STATOR OR ROTOR OF AN ELECTRICAL MACHINE, AND ELECTRICAL MACHINE

(71) Applicant: JHEECO E-DRIVE AG, Eschen (LI)

(72) Inventors: Pascal HUSER, Birmenstorf (CH); Martin STÖCK, Salez (CH); Fabian LOSCH, Buchs (CH)

(21) Appl. No.: 17/289,981

(22) PCT Filed: Oct. 30, 2019
(86) PCT No.: PCT/EP2019/079710

§ 371 Date: Apr. 29, 2021

(30) Foreign Application Priority Data
Oct. 31, 2018 (DE) 10 2018 218 732.0

(51) Int. Cl. H02K 3/24; H02K 3/34; H02K 9/19; H02K 15/04; H02K 15/10

(52) U.S. Cl. CPC H02K 3/24; H02K 3/34; H02K 15/105; H02K 15/0414; H02K 9/19

(57) ABSTRACT

The present invention relates to a compressed strand comprising a wire pack consisting of at least two wires, wherein at least one head end of the compressed strand, preferably both head ends, has/have a contact-making section and a heat-exchange section, and to a stator or rotor of an electric motor, wherein the rotor or stator, respectively, is equipped with at least one compressed strand according to at least one of the preceding claims, and to an electric motor, comprising a stator and a rotor, characterized by a stator and/or rotor according to at least one of the preceding claims.

The present invention relates to a compressed strand according to the preamble of claim 1, a rotor and/or stator according to the preamble of claim 9, and an electrical machine, in particular an electric motor according to the preamble of claim 12.

An electric motor typically comprises a rotor (armature) and a stator, the rotor being mounted rotatably about a central axis relative to the stator. To create magnetic forces, windings are provided in the stator which are correspondingly supplied with current. To create the stator energizing field, axially extending slots for receiving a current-carrying winding are often introduced in the core stack of the stator distributed across the circumference, wherein only the portion of a coil extending axially within the slot contributes to the torque. It is also referred to as the active length. A plurality of coils can be placed within one slot. In contrast, those portions of the coil which connect the active lengths at the front ends of the core stack are torque-blind. This portion of the winding located axially outside the core stack is also referred to as winding head.

Coils usually consist of a plurality of (thin) wires insulated with respect to each other (enamelled wire) which are inserted directly into a pair of slots wound-up or as prefabricated coil. To fill the slot's cross-section with more copper (a higher level of slot packing to increase current density), coils with only one (thick) “wire” (solid wire) are also commonly used, wherein then typically a plurality of (4-8) coils are inserted per slot.

To facilitate the manufacture and assembly, it is known to use coils composed of individual segments (segmental conductors). Here, segmental conductors (bar-type conductors) essentially corresponding to the slot's shape are preferably axially inserted into slots. The winding head can only be finished after the segmental conductor has been inserted by connecting the head ends of two segmental conductors each in pairs. In the process, segmental conductors can be contacted via winding heads. Segmental conductors are, among others, I-shaped (bar-type conductor) and U-shaped (hairpin conductor) ones which are often designed as single-piece solid wires.

Multi-piece segmental conductors (compressed strands) are a special case. Compressed strands are conductors composed of a plurality of individual wires (strands) preferably electrically insulated with respect to each other, wherein the cross-section is compressed or compacted into a desired shape. Strands can also be considered as wire packs. Only in the head ends of a compressed strand provided for further contacting, the individual wires are electrically and mechanically connected to each other, wherein any present insulation in the head region is or will be advantageously removed. This is done, for example, by hot crimping/electrode welding of the head end with a sleeve. The strand altogether or individual branches of the strand can be twisted with respect to each other. Such compressed strands have become known, for example, in DE112015001994A5. They can be advantageously employed in electric motors operated with (high-frequency) alternating current to reduce parasitic effects, such as eddy currents and skin effects.

The winding heads of electric motors become very hot. In order to avoid thermal failure, these are therefore often cooled. As a cooling medium, a dielectric fluid is employed (typically an oil). Oil cooling is in most cases realized via a “cooling cap” which forms a ring channel surrounding the winding head, and in which a cooling medium is flowing. Such a cooling is represented, for example, in DE102017107165A1.

In composed windings—i. e. segmental conductors which are inserted into stator slots and subsequently connected to each other directly or indirectly—this type of winding head cooling is known. Directly means e. g. bending the bar-type conductors towards each other and directly welding them; indirectly means the application of interconnection webs which bridge the distance between two bar-type conductors. For an example of interconnection webs, see e. g. U.S. Pat. No. 4,321,497A, for an example of bending towards each other, see e. g. US2014070639A1.

For an effective cooling, it is advantageous to cool those portions where a high heat transfer coefficient can be achieved. These are in particular those portions where no insulation (main insulation and, in case of a compressed strand, also individual wire insulation) hinders the heat transfer between the cooling medium and the electric conductor. At the same time, however, a sufficient electric insulation or a sufficiently long leakage path has to be provided between the individual conductors to avoid short-circuits and flashovers.

For this reason, a) complete winding heads are completely cast with resin, or b) the connection zones are individually coated with insulating resin or insulating covers. Both options are disadvantageous because they hinder thermal heat transfer. As an alternative, the distances between the contact-making points are selected large enough for a separate insulation not to be required anymore. Another possibility is to insert strips of insulating paper.

If interconnection webs are used, these should analogously also be insulated with respect to each other. For this, interconnection webs are coated e.g. with an insulating resin, an insulating paper is inserted, or insulating spacers are introduced.

While the already known cooling options of the winding head region achieve quite good results, there is still need for improvement.

Correspondingly, the object of the present invention is to suggest a compressed strand which permits better cooling.

According to the invention, this object is achieved by a compressed strand having the characterizing features of claim 1. By at least one head end, preferably both head ends, of the compressed strand, which has a wire pack (strand) brought into shape for conducting electric current, comprising an electric contact-making section and a heat-exchange section, an essentially more effective cooling of the compressed strand can be achieved in the region of the head ends.

Further advantageous embodiments of the suggested invention in particular result from the features of the subclaims. The objects or features of the different claims can be basically arbitrarily combined with each other.

In an advantageous embodiment of the invention, the wire pack, and in particular the wires of the wire pack, can be surrounded by an electric insulation.

In another advantageous embodiment of the invention, the electric contact-making section may be formed of a sleeve, in particular a metal sleeve, surrounding the at least two wires, or of a welding of the at least two wires. The two possibilities represent advantageous, production-related for the manufacture of the contact-making region. Preferably, the wires are stripped in the contact-making section.

In a further advantageous embodiment of the invention, the heat-exchange section can be designed as a wire bundle, in particular a wire bundle formed of the individual wires of the compressed strand. Wire bundle is here to be understood as a fanned-out section of a wire pack or a strand, respectively, wherein the individual wires of the wire pack are no longer lying in a strict order and in direct contact one next to the other. A wire bundle can be relatively easily made from the usually twisted wires of the compressed strand. Moreover, a cooling medium can flow around all sides of the wires of the wire bundle, such that a large heat-exchange surface is provided.

In a further advantageous embodiment of the invention, the wires can be, in the heat-exchange section, preferably untwisted and/or spliced in sections. These measures mainly serve to enlarge the provided heat-exchange surface.

In a further advantageous embodiment of the invention, the wires may not be insulated in the heat-exchange section. This measure, too, serves to improve the heat transfer between the wire or the wires, respectively, and the respective cooling medium.

In a further advantageous embodiment of the invention, the heat-exchange section may be embodied as an extension of the compressed strand over the contact-making region.

In a further advantageous embodiment of the invention, the heat-exchange section can be embodied in a shape suited for guiding and/or swirling the cooling medium. These fluid flow guide elements can provide an additional swirling of the cooling flow and thus increase the heat transfer altogether since less quasi-static boundary layers are formed.

A further object of the present invention is to suggest an improved rotor and/or stator for an electric motor, in particular to suggest a rotor and/or stator which can be better cooled.

According to the invention, this object is achieved by a rotor and/or stator having the characterizing features of claim 9. The advantages of the compressed strand according to the invention can correspondingly be utilized for the rotor and/or stator.

Further advantageous embodiments of the suggested invention in particular result from the features of the subclaims. The objects or features of the different claims can be basically arbitrarily combined with each other.

In an advantageous embodiment of the invention, the at least two compressed strands can be connected to each other via the contact-making section.

In a further advantageous embodiment of the invention, the connection of the at least two compressed strands can be electrically connected to each other by means of welding or by means of an interconnection web. By means of welding in particular means the direct welding of two contact-making sections of two compressed strands. By means of an interconnection web in particular means the indirect connection of two contact-making sections of compressed strands via an interconnection web. The contact-making sections of the compressed strand and interconnection webs can be welded.

A further object of the present invention is to suggest an improved electrical machine, in particular an improved electric motor, in particular to suggest an electrical machine, in particular an electric motor, which can be better cooled.

According to the invention, this object is achieved by an electrical machine, in particular electric motor, having the characterizing features of claim 12. The advantages of the rotor and/or stator according to the invention can be correspondingly utilized for the electrical machine.

Further advantageous embodiments of the suggested invention in particular result from the features of the subclaims. The objects or features of the different claims can be basically arbitrarily combined with each other.

In an advantageous embodiment of the invention, the electrical machine can be equipped with a cooling means for cooling the heat-exchange sections.

In a further advantageous embodiment of the invention, a fluid, in particular on oil, can be admitted to the cooling means for cooling purposes.

Further features and advantages of the present invention will become clear with respect to the following description of preferred exemplified embodiments with reference to the enclosed drawings. In the drawings

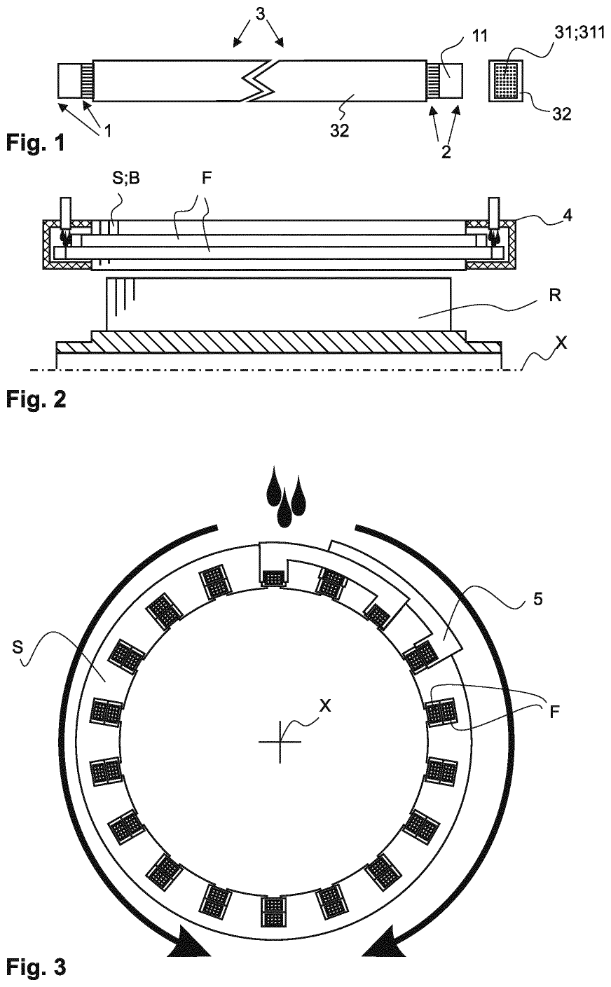

FIG. 1 shows a compressed strand according to prior art;

FIG. 2 shows a representation of an electric motor with a cooling means for the winding heads in a cross-sectional view (upper part);

FIG. 3 shows a stator of an electric motor in a cross-sectional representation;

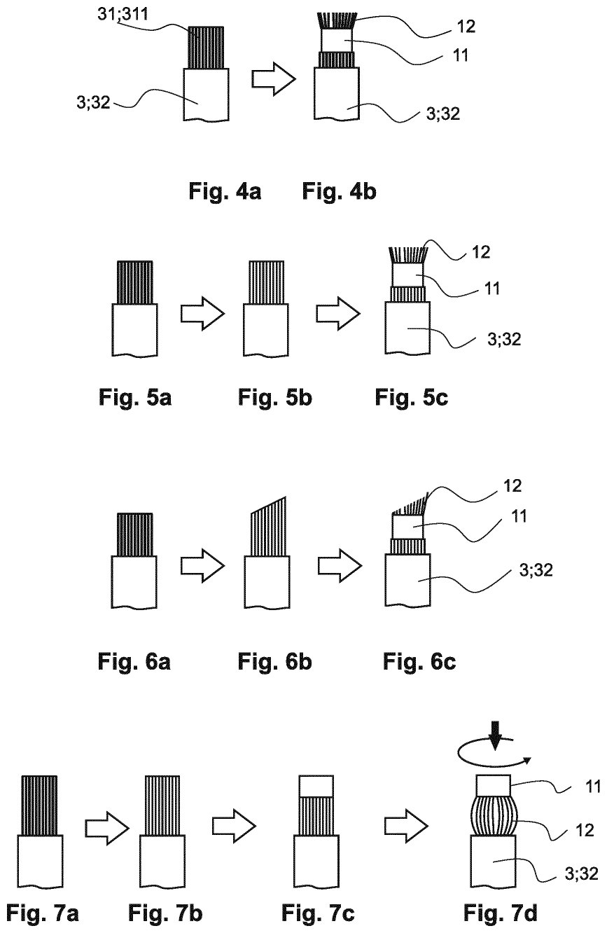

FIG. 4 shows a schematic manufacturing process of a compressed strand according to the invention and an end of a compressed strand according to the invention;

FIG. 5 shows a schematic manufacturing process of a compressed strand according to the invention and an end of a compressed strand according to the invention;

FIG. 6 shows a schematic manufacturing process of a compressed strand according to the invention and an end of a compressed strand according to the invention;

FIG. 7 shows a schematic manufacturing process of a compressed strand according to the invention and an end of a compressed strand according to the invention;

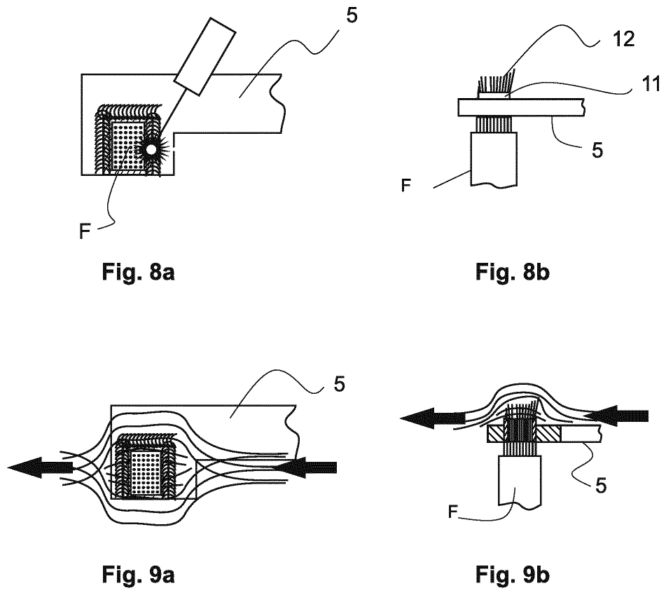

FIG. 8 shows a schematic representation of a connection process between the compressed strand and the interconnection web by means of welding;

FIG. 9 shows a schematic representation of a compressed strand according to the invention with respect to an incoming flow by means of a cooling medium;

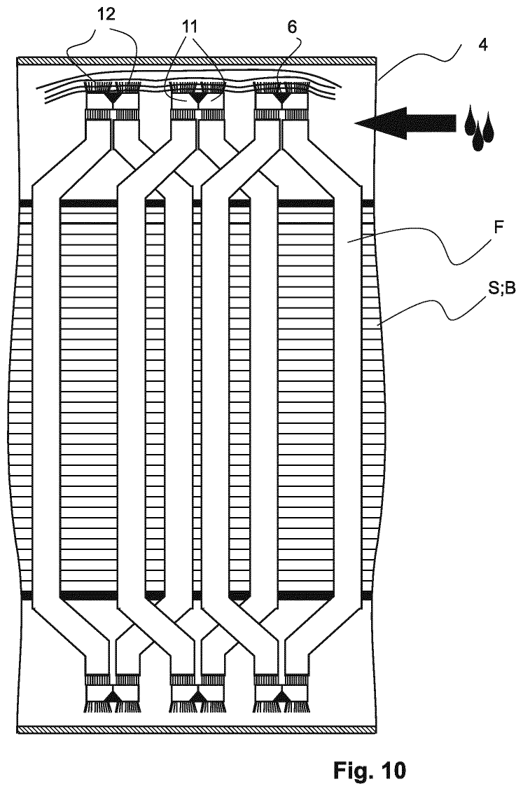

FIG. 10 shows a rotor according to the invention with a plurality of compressed strands connected to each other, in particular welded to each other, via the contact-making regions.

A compressed strand F according to the invention essentially comprises a first head end 1 as well as a second head end 2. A wire pack 3 is arranged between these head ends 1, 2.

The wire pack 3 consists of a number of wires 31, at least, however, two wires, which are usually twisted and are preferably surrounded by a main insulation layer 32 as a wire pack. The compressed strand is moreover compacted and preferably has a rectangular or trapezoidal cross-sectional area. The wires 31, preferably of copper or a copper alloy, as such can also be individually equipped with an insulation 311, or else they may not be insulated or partially stripped, in particular at the head ends.

According to the invention, at least one head end 1 or 2 of the compressed strand, preferably both head ends 1 and 2, comprise a contact-making section 11 and a heat-exchange section 12.

In the region of the contact-making section 11, the wire sections located there are electrically and mechanically connected to each other, which can be done by means of sleeves of metal or else by welding the individual wires 31 in this region.

The heat-exchange section 12 is preferably embodied as a wire bundle, in particular, the wire bundle is formed of the individual wires 31 of the compressed strand, wherein the individual wires are preferably un-twisted and/or spliced in sections in the heat-exchange section.

The individual wires 31 are preferably stripped in the heat-exchange section 12, in particular not only of the common main insulation 32, but also of the optionally provided individual wire insulation 311. The additional cooling surface formed by the heat-exchange section 12 can be embodied as an extension of the compressed strand F over the contact-making region 11. In this case, it is not used for carrying current but primarily has the function of a thermal bridge. The region can be embodied in different cross-sectional shapes, in particular for guiding and/or swirling the cooling medium. As a result, a cooling surface is suggested which is increased compared to the cross-section of the compressed strand and which is formed by individual wire surfaces.

The heat-exchange section 12 can be arranged, with respect to the wire pack 3, between the wire pack 3 and the contact-making section 11, or next to the contact-making section 11, that means at the end side of the compressed strand. In the first case, a sequence of wire pack 3, heat-exchange section 12, contact-making section 11 is formed, while in the second case, a sequence of wire pack 3, contact-making section 11, and heat-exchange section 12 results in the longitudinal direction of the compressed strand. The heat-exchange section 12 and the contact-making section 11 are normally separate regions.

The provision of a heat-exchange section 12 has numerous advantages.

For example, the cooling effect is high due to the increased cooling surface. This can be illustrated with reference to a sample calculation. A normal compressed strand head creates a heat-exchange surface with about 3*6*10 mm=150 mm². With 15 wires having a diameter of 1 mm², a heat-exchange section 12 according to the invention creates a heat-exchange surface of approximately (d*pi)*h=1*3.14*10=314 mm².

The heat-exchange section 12 offers an additional impact area for a cooling medium flowing therethrough. The heat transfer can thus be locally increased.

The heat-exchange section 12 can form fluid flow guide elements (not shown) which take care of an additional swirling of the cooling flow and thus increase the heat transfer altogether since less quasi-static boundary layers are formed.

At least one of the above-described compressed strands F can be installed in the stator S and/or rotor R of an electrical machine, in particular an electric motor. As an electrical machine, an electric motor and/or an electric generator, for example also within one aggregate, is possible. To achieve a heat-exchange surface as large as possible, each one or a large number of the compressed strands used is/are preferably compressed strands F according to the invention with the corresponding heat-exchange sections 12.

In this context, at least two compressed strands F can be connected to each other via their contact-making section 11 at least electrically, preferably electrically and mechanically. This can be achieved, for example, by a welding 6 of the contact-making regions 11 as well as by a connection of the contact-making regions by means of an interconnection web 5. The connection of the interconnection web and the compressed strand can also be designed as a welding. The invention can equally be employed for direct interconnections and for indirect interconnections with interconnection webs.

An electrical machine according to the invention, in particular an electric motor, in turn comprises a rotor R and/or stator S according to the invention with at least one compressed strand F according to the invention. Preferably, such an electrical machine is equipped with a cooling means 4 for cooling the heat-exchange sections. The cooling means 4 can comprise, for example, a cooling cap which is arranged around the compressed strand ends, but in particular the heat-exchange sections 12. It is preferably provided for the cooling means 4 to be embodied for cooling by means of a fluid, in particular an oil. To this end, an oil supply can be incorporated in the cooling cap.

To the figures in detail:

In FIG. 1, a compressed strand according to prior art only with contact-making regions 11 in the form of sleeves is shown. Between the contact-making regions 11, the wire pack 3 is arranged. In the cross-section, the individual wires 31 can be seen.

In FIG. 2, a cross-section of an electrical machine according to the invention, in particular an electric motor, comprising the rotor R and stator S is shown (upper part) with an axis X. Furthermore, one can see the essential elements of the cooling means, in particular the cooling cap 4 and the oil supply (without reference numeral).

In FIG. 3, the stator S of the electrical machine, in particular the electric motor, is depicted in a cross-sectional representation. The flow direction of a cooling medium, for example oil, as well as, by way of example, two interconnection webs 5 are indicated. Two compressed strands F according to the invention are provided per slot.

In FIGS. 4 to 7, different embodiments of compressed strands F according to the invention or their head ends 1, respectively, are represented. Furthermore, individual manufacturing steps are schematically indicated.

In FIG. 4a, for example, a compressed strand blank with insulated individual wire ends 31 and 311 as well as its main insulation 32 are represented. In FIG. 4b, the heat-exchange section 12 and the contact-making section 11 in the form of a sleeve can be seen. The sleeve is applied, for example, by means of electrode welding. The heat-exchange section 12 is embodied, for example, as a protruding projection. Splicing is done, for example, automatically when the sleeve is applied or pressed, respectively.

In FIG. 5b, a possible intermediate step in the manufacture of a compressed strand according to the invention is represented, in particular the stripping of the insulation varnish 311 of the individual wires 31 for a better heat transfer.

In FIG. 6b, a triangular design of the heat-exchange section end is represented.

In FIG. 7, an example of an end-sided contact-making region and a heat-exchange section 12 arranged between the wire pack 3 and the contact-making region 11 is represented.

In FIG. 7b, a partial stripping of the individual wires 31 in the head region of the compressed strand F is represented, this concerning both the contact-making section and the heat-exchange section. In FIG. 7c, the creation of a contact-making section 11 by applying a sleeve at the end of the stripped individual wires 31 is represented.

The untwisting, represented in FIG. 7d, leads to a bloating of a heat-exchange section 12 between the wire pack 3 and the contact-making region 11.

In FIG. 8a, a welding of a compressed strand 3, in particular the contact-making region 11, with an interconnection web 5 is represented. In FIG. 8a, an exemplary projection of the heat-exchange section 12 is represented.

FIGS. 9a and 9b, respectively, schematically show how the cooling medium flows through the heat-exchange section 12. In the process, the cooling medium flows through the complete wire bundle, and not only through an outer contour.

In FIG. 10, an unwinding of a stator S or stator wire pack B, respectively, according to the invention is shown in sections, wherein the compressed strands are bent towards each other in pairs. The contact regions 11 of the compressed strands F are directly welded to each other, that means they include a welding 6. The winding head is enclosed by a cooling cap, and an oil flows therethrough. By the heat-exchange sections 12 embodied as a projection, the heat transfer of the compressed strands F otherwise surrounded by a main insulation can be improved.

Features and details described in connection with a method naturally also apply in connection with the device according to the invention, and vice versa, so that with respect to the disclosure, mutual reference is made, and can be made, to the individual aspects of the invention.

1. Compressed strand, comprising a wire pack of at least two wires for conducting electric current, wherein at least one head end of the compressed strand comprises an electric contact-making section and a heat-exchange section.

2. Compressed strand according to claim 1, wherein the wire pack, are surrounded with an electric insulation.

3. Compressed strand according to claim 1, wherein the contact-making section is formed of a sleeve surrounding the at least two wires at the end side, or of a welding of the at least two wires at the end side.

4. Compressed strand according to claim 1, wherein the heat-exchange section is embodied as a wire bundle.

5. Compressed strand according to claim 1, wherein the wires in the heat-exchange section are untwisted and/or spliced, respectively, in sections.

6. Compressed strand according to claim 1, wherein the wires are not insulated in the heat-exchange section.

7. Compressed strand according to claim 1, wherein the heat-exchange section is embodied as an extension of the compressed strand over the contact-making region (11).

8. Compressed strand according to claim 1, wherein the heat-exchange section is embodied in a form suited for guiding and/or swirling a cooling medium.

9. Stator or rotor of an electrical machine, in particular an electric motor and/or an electric generator, wherein the rotor or stator is equipped with at least one compressed strand according to claim 1.

10. Stator or rotor according to claim 9, wherein at least two compressed strands are connected to each other via the contact-making section.

11. Stator or rotor according to claim 1, wherein the at least two compressed strands are connected to each other by means of welding or by means of an interconnection web.

12. Electrical machine, in particular electric motor and/or electric generator, comprising a stator and a rotor, according to claim 9.

13. Electrical machine according to claim 12, wherein the electric motor is equipped with a cooling means for cooling the at least one heat-exchange section.

14. Electrical machine according to claim 12, wherein a fluid, is admitted to the cooling means.

15. Compressed strand according to claim 2, wherein the wires of the wire pack are surrounded with an electric insulation.

16. Compressed strand according to claim 3, wherein the sleeve is a metal sleeve.

17. Compressed strand according to claim 4, wherein the wire bundle is formed of the wires of the compressed strand.

18. Electrical machine according to claim 12, wherein an oil is admitted to the cooling means.
